(19) United States
(12) Patent Application Publication
(10) Pub. No.: US 2026/0175193 A1
(43) Pub. Date: Jun. 25, 2026

(54) MODIFIED COVALENT ORGANIC FRAMEWORK FOR SIMULTANEOUS ADSORPTION OF MULTIPLE HEAVY METAL IONS AND PREPARATION METHOD THEREOF

(71) Applicants: Henan Business Science Research Institute Co., Ltd, Henan (CN); Zhengzhou Tobacco Research Institute of CNTC, Henan (CN); Henan Academy of Sciences, Henan (CN)

(72) Inventors: Libin Wan, Henan (CN); Shucai Gao, Henan (CN); Haidong Gao, Henan (CN); Mantang Chen, Henan (CN); Na Li, Henan (CN); Fayun Wang, Henan (CN); Hongwei Liu, Henan (CN)

(73) Assignees: Henan Business Science Research Institute Co., Ltd, Henan (CN); Zhengzhou Tobacco Research Institute of CNTC, Henan (CN); Henan Academy of Sciences, Henan (CN)

(21) Appl. No.: 19/369,317

(22) Filed: Oct. 26, 2025

(30) Foreign Application Priority Data
Dec. 25, 2024 (CN) 202411924014.2

(51) Int. Cl. B01J 20/22; B01J 20/30; C02F 1/28; C02F 101/20; C02F 101/22

(52) U.S. Cl. CPC B01J 20/226; B01J 20/3071; B01J 20/3085; C02F 1/288; C02F 2101/206; C02F 2101/22

(57) ABSTRACT

The disclosure belongs to a field of environmentally friendly new materials, specifically relating to a modified covalent organic framework for simultaneous adsorption of multiple heavy metal ions, along with its preparation method and applications. The preparation steps for the material are as follows. 1,3,5-tris(4-aminophenyl)benzene and 2,5-dihydroxyterephthalaldehyde are dissolved in a mixed solvent and allowed to stand and react at room temperature to obtain a mixed solution. Scandium trifluoromethanesulfonate is added to the obtained mixed solution, and allowed to stand and react at the room temperature. After completion of the reaction, the insoluble matter is separated from the reaction solution, and the insoluble matter is washed and dried to obtain a covalent organic framework substrate. A neutral solution is used to perform an ultrasonic modification treatment on the covalent organic framework substrate prepared, and then the modified substrate is washed and dried to obtain a modified covalent organic framework.

### CROSS-REFERENCE TO RELATED APPLICATION

This application claims the priority benefit of China application serial no. 202411924014.2, filed on Dec. 25, 2024, now allowed. The entirety of the above-mentioned patent application is hereby incorporated by reference herein and made a part of this specification.

### BACKGROUND

### Technical Field

The disclosure belongs to a field of new environmentally friendly materials, and more particularly, relates to a modified covalent organic framework for simultaneous adsorption of multiple heavy metal ions and a preparation method thereof.

### Description of Related Art

Heavy metal wastewater is one of the common pollutants discharged in industrial production. A large amount of toxic heavy metal pollutants enter a water body, causing serious pollution to a water environment. Heavy metal ions are difficult to be naturally degraded and have high biological activity, persistence, and biological magnification, and may produce strong biological effects and “three-hazard” effects (including mutagenesis, carcinogenesis, and teratogenesis) even at very low exposure concentrations, seriously endangering human health and ecological safety. In addition, combined exposure between multiple heavy metal ions in the environment and between the heavy metal ions and coexisting organic pollutants may produce synergistic toxic effects on organisms. Studies have shown that existing sewage treatment plants are unable to effectively remove heavy metal pollutants from urban sewage. As a result, these pollutants are frequently detected in the effluent of sewage treatment plants and related water bodies, and accumulation in various environmental media such as sediments and soils. Although the concentration of the heavy metal ions in the effluent from the sewage treatment plants is relatively low, the heavy metal ions may still cause serious harm to the human health through biomagnification in the food chain due to their bioaccumulative nature. Therefore, it is necessary to develop a method that can simultaneously and deeply remove multiple low-concentration heavy metal ions in micro-polluted water.

An adsorption method is one of the most effective methods for removing the heavy metal ions. However, although existing adsorbents have good removal efficiency on high-concentration heavy metal ions, the removal performance for the low-concentration heavy metal ions is poor. A main reason is that the selective adsorption ability of the existing adsorbents for heavy metal ions is insufficient, resulting in the adsorbents reaching adsorption-desorption equilibrium after adsorbing a small amount of the low-concentration heavy metal ions, and thus failing to achieve further deep removal of the heavy metal ions. Compared with conventional adsorbents, covalent organic frameworks are organic porous materials with periodic network structures formed by light elements via covalent bonds, which not only have advantages such as high specific surface area, regular and orderly pore channels, and easy functional modification, but also have good thermal stability and chemical stability. In order to improve the adsorption capacities of covalent organic frameworks on the heavy metal ions, researchers usually use the chelating effect of active groups on heavy metal ions and adopt two methods to synthesize the functionalized covalent organic frameworks: one is to pre-design precursors modified with specific free groups as organic monomers to prepare modified covalent organic frameworks with specific functions, and the other is the post-synthesis group re-modification strategy for covalent organic frameworks. It should be noted that since different active groups will produce different degrees of chelating effect between different types of heavy metal ions, although the modified covalent organic frameworks prepared by the above methods may enhance the adsorption capacities for specific heavy metal ions, it is difficult to achieve efficient simultaneous adsorption and removal of multiple low-concentration heavy metal ions. In addition, most modified covalent organic frameworks are synthesized through solvothermal methods, which require high reaction temperatures, long reaction time, harsh reaction conditions, and high costs, limiting their application in water purification.

### SUMMARY

In view of the problems and shortcomings in the related art, an objective of the disclosure is to provide a modified covalent organic framework for simultaneous adsorption of multiple heavy metal ions and a preparation method thereof.

Based on the above objective, the disclosure adopts the following technical solutions:

The first aspect of the disclosure provides a preparation method of a modified covalent organic framework for simultaneous adsorption of multiple heavy metal ions, comprising the following steps:
(1) dissolving 1,3,5-tris(4-aminophenyl)benzene and 2,5-dihydroxyterephthalaldehyde in a mixed solvent and allowing the reaction to stand at room temperature to obtain a mixed solution;
(2) adding scandium trifluoromethanesulfonate to the mixed solution obtained in step (1), and allowing the reaction to stand at the room temperature. After completion of the reaction, separating the insoluble matter from the reaction solution, and then washing and drying the insoluble matter to obtain a covalent organic framework substrate; and
(3) using a neutral solution to perform an ultrasonic modification treatment on the covalent organic framework substrate prepared in step (2), and then washing and drying the modified substrate to obtain the modified covalent organic framework.

Preferably, the neutral solution described in step (3) is any one of a magnesium chloride aqueous solution, a sodium chloride aqueous solution, and a potassium chloride aqueous solution, and the concentration of the neutral solution is 0.5 to 3 mol/L.

More preferably, the neutral solution is a magnesium chloride aqueous solution, and the concentration of the magnesium chloride aqueous solution is 0.5 to 3 mol/L.

Even more preferably, the concentration of the magnesium chloride aqueous solution is 1 mol/L.

Preferably, the molar ratio of 1,3,5-tris(4-aminophenyl)benzene to 2,5-dihydroxyterephthalaldehyde in step (1) is 2:3.

Preferably, the mixed solvent in step (1) is a mixed solvent of 1,4-dioxane and 1,3,5-trimethylbenzene.

Preferably, the volume ratio of 1,4-dioxane to 1,3,5-trimethylbenzene is (1-5): 1.

More preferably, the volume ratio of 1,4-dioxane to 1,3,5-trimethylbenzene in the mixed solvent is 4:1.

Preferably, the molar ratio of 1,3,5-tris(4-aminophenyl)benzene to scandium trifluoromethanesulfonate is (10-150): 1.

More preferably, the molar ratio of 1,3,5-tris(4-aminophenyl)benzene to scandium trifluoromethanesulfonate is 16:1.

Preferably, the standing reaction time for both step (1) and step (2) is 10 to 60 minutes.

Preferably, the detergent for washing the insoluble matter in step (2) is at least one of methanol, ethanol, and acetone.

Preferably, the washing method in step (3) is washing with water and methanol in sequence.

Preferably, the drying temperature in both step (2) and step (3) is 50 to 100° C., and drying time is 10 to 24 h.

The second aspect of the disclosure provides a modified covalent organic framework for simultaneous adsorption of multiple heavy metal ions prepared by the method in the above first aspect.

The third aspect of the disclosure provides an application of the modified covalent organic framework in the above second aspect in removal and purification of multiple heavy metal ions in a water body.

Preferably, the modified covalent organic framework is applied to adsorb and remove lead ion, chromium (III) ion, cobalt ion, nickel ion, manganese ion, and copper ion in water.

Preferably, when the modified covalent organic framework is used as a water adsorbent, 0.05 g to 10 g of the modified covalent organic framework can be added in per liter of water containing heavy metal ions at a concentration of 0.01 mg/L to 20 mg/L.

Compared with the related art, the disclosure has the following beneficial effects:
(1) Compared to the conventional preparation methods of the covalent organic framework (high-temperature and high-pressure hydrothermal method combined with chemical synthesis method), in the disclosure, a simple room-temperature synthesis method and a rapid ultrasonic modification strategy using a neutral solution are used to prepare the modified covalent organic framework. This method features simple operation, short preparation time, easy operation for the modification strategy, mild conditions, short time consumption and high yield, and high performance stability and reproducibility. This modification technology can greatly improve the adsorption capacity of the covalent organic framework for heavy metal ions and has good application potential. Especially when the magnesium chloride solution is used as the modifier, it shows good adsorption effects on the six heavy metal ions in a mixed multicomponent system.

In addition, the simple ultrasonic modification treatment performed on the covalent organic framework material using the neutral magnesium chloride solution does not affect the surface morphology of the covalent organic framework. Although it causes a slight decrease in the specific surface area of the covalent organic framework, it greatly improves the adsorption capacity for multiple heavy metal ions. The modified covalent organic framework prepared by this room-temperature synthesis method and magnesium chloride ultrasound strategy provided in the disclosure can be effectively applied to the removal of multiple heavy metal ions from water. In contrast, the existing modified covalent organic framework can only achieve the adsorption of the specific heavy metal ions, but cannot realize the efficient simultaneous adsorption and removal of multiple heavy metal ions from water.

### BRIEF DESCRIPTION OF THE DRAWINGS

FIG. 1 is the X-ray diffraction (XRD) patterns of a modified covalent organic framework in Example 1 and an unmodified covalent organic framework prepared in Comparative Example 1 in the disclosure.

FIG. 2A is a scanning electron microscope (SEM) image of the unmodified covalent organic framework in Comparative Example 1 of the disclosure, and FIG. 2B is a scanning electron microscope (SEM) image of the modified covalent organic framework in Example 1 of the disclosure.

FIG. 3 is a graph showing adsorption rates of the covalent organic framework in Example 1 of the disclosure for multiple heavy metal ions under different solution pH conditions in a single system.

FIG. 4 is a graph showing thermodynamic adsorption isotherms of the modified covalent organic framework in Example 1 of the disclosure for heavy metal ions in a mixed multicomponent system.

FIG. 5 is a graph showing kinetic adsorption isotherms of the modified covalent organic framework in Example 1 of the disclosure for heavy metal ions in a mixed multicomponent system.

FIG. 6 is a graph showing adsorption rates of the modified covalent organic framework in Example 1 of the disclosure for simultaneous adsorption of six mixed heavy metal ions at concentrations of 0.01, 0.05, and 0.1 mg/L in the mixed multicomponent systems.

### DETAILED DESCRIPTION OF DISCLOSED EMBODIMENTS

In order for the objectives, technical solutions, and advantages of the disclosure to be more clearly understood, the disclosure is further described in detail below through embodiments accompanied with drawings. It should be understood that the specific embodiments described herein are only used to explain the disclosure and are not intended to limit the disclosure.

It should be noted that the embodiments in the disclosure and features in the embodiments can be combined with each other without conflict. The disclosure will be described in detail below with reference to the accompanying drawings and in combination with the embodiments.

### (I) Preparation of a Modified Covalent Organic Framework for Simultaneous Adsorption and Removal of Multiple Heavy Metal Ions

### Example 1

A preparation method of a modified covalent organic framework for simultaneous adsorption of multiple heavy metal ions included the following steps:
(1) 210.8 mg of 1,3,5-tris(4-aminophenyl)benzene and 149.5 mg of 2,5-dihydroxyterephthalaldehyde were respectively weighed and taken into a 50 mL conical flask, and 19.2 mL of 1,4-dioxane and 4.8 mL of 1,3,5-trimethylbenzene were added therein, so as to be dissolved by ultrasonication and allowed to stand and react at room temperature for 20 min to obtain a mixed solution;
(2) 18 mg of scandium trifluoromethanesulfonate was added to the mixed solution obtained in step (1) to be dissolved by ultrasonication and allowed to stand and react at the room temperature for 20 min. After the reaction was completed, an insoluble matter was separated from a reaction solution by centrifugation, and the insoluble matter was washed by centrifugation with methanol three times and subjected to vacuum drying at 70° C. for 12 h. An obtained material was called a covalent organic framework substrate;
(3) 300 mg of the covalent organic framework substrate obtained in step (2) was weighed and dispersed in 300 mL of a 1 mol/L neutral magnesium chloride aqueous solution, subjected to ultrasonication for 30 min, separated by centrifugation and then washed with water and methanol three times respectively, and subjected to vacuum drying at 70° C. for 12 h to obtain the modified covalent organic framework.

### Example 2

A preparation method of a modified covalent organic framework for simultaneous adsorption of multiple heavy metal ions was provided. The preparation method was substantially the same as that of Example 1, except that the concentration of the magnesium chloride aqueous solution in step (3) was 0.5 mol/L.

### Example 3

A preparation method of a modified covalent organic framework for simultaneous adsorption of multiple heavy metal ions was provided. The preparation method was substantially the same as that of Example 1, except that the concentration of the magnesium chloride aqueous solution in step (3) was 2 mol/L.

### Example 4

A preparation method of a modified covalent organic framework for simultaneous adsorption of multiple heavy metal ions was provided. The preparation method was substantially the same as that of Example 1, except that the concentration of the magnesium chloride aqueous solution in step (3) was 3 mol/L.

### Example 5

A preparation method of a modified covalent organic framework for simultaneous adsorption of multiple heavy metal ions was provided. The preparation method was substantially the same as that of Example 1, except that the neutral solution in step (3) was a sodium chloride aqueous solution.

### Example 6

A preparation method of a modified covalent organic framework for simultaneous adsorption of multiple heavy metal ions was provided. The preparation method was substantially the same as that of Example 1, except that the neutral solution in step (3) was a potassium chloride aqueous solution.

### Comparative Example 1

A preparation method of a covalent organic framework substrate (i.e., an unmodified covalent organic framework) for simultaneous adsorption and removal of multiple heavy metal ions was provided. The preparation method was substantially the same as that of Example 1, except that there was no modification treatment in step (3).

### Comparative Example 2

A preparation method of a modified covalent organic framework for simultaneous adsorption of multiple heavy metal ions was provided. The preparation method was substantially the same as that of Example 1, except that a sodium hydroxide alkaline solution was selected to perform the modification treatment on the material in step (3).

### Comparative Example 3

A preparation method of a modified covalent organic framework for simultaneous adsorption of multiple heavy metal ions was provided. The preparation method was substantially the same as that of Example 1, except that a potassium hydroxide alkaline solution was selected to perform the modification treatment on the material in step (3).

### Comparative Example 4

A preparation method of a modified covalent organic framework for simultaneous adsorption of multiple heavy metal ions was provided. The preparation method was substantially the same as that of Example 1, except that an ammonia alkaline solution was selected to perform the modification treatment on the material in step (3).

### (II) Structural Characterization of the Modified Covalent Organic Framework

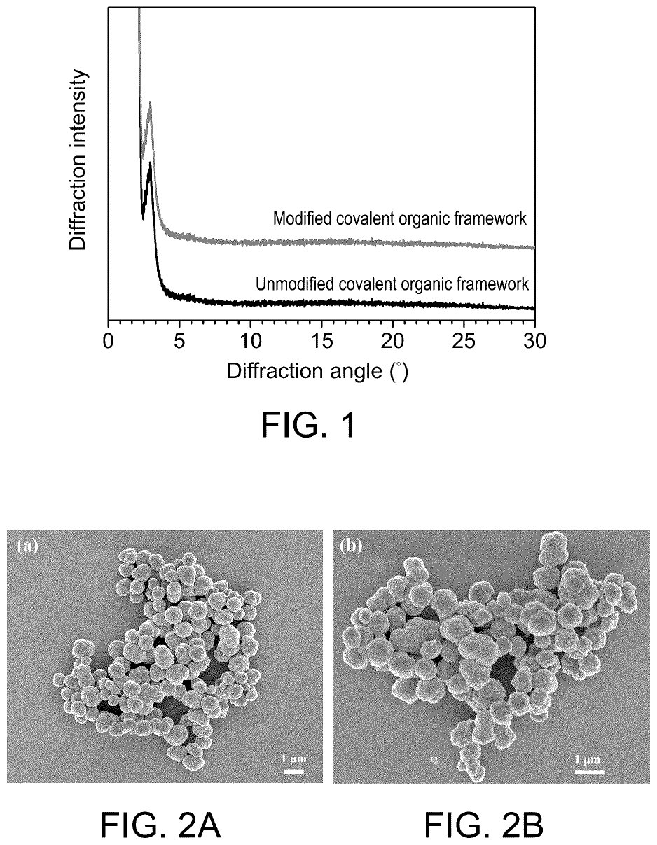

Crystal structures of the modified covalent organic framework and unmodified covalent organic framework prepared in Example 1 and Comparative Example 1 were characterized by an X-ray diffractometer (XRD), and the results were shown in FIG. 1. As can be seen from FIG. 1, a high-intensity peak was observed at 2.9° for both materials, which was caused by [100] crystal plane reflection of the covalent organic framework, which showed that modification of magnesium chloride did not affect the crystal structure of the covalent organic framework substrate material.

Morphological structures of the modified covalent organic framework and the unmodified covalent organic framework prepared in Example 1 and Comparative Example 1 were observed through a SEM electron microscope. As shown in FIG. 2, both materials have a spherical structure with a relatively dense surface, and their particle sizes were about 1 μm. The modification of magnesium chloride did not cause significant changes in the particle sizes and basic morphologies of the materials.

### (III) Study on Adsorption Performance of Modified Covalent Organic Framework Prepared Under Different Conditions for Multiple Heavy Metal Ions

In a mixed multicomponent system, adsorption performance of modified covalent organic frameworks prepared in Examples 1 to 6 and Comparative Examples 2 to 4 and the unmodified covalent organic framework substrate prepared in Comparative Example for six heavy metal ions (Pb²⁺, Cr³⁺, Co²⁺, Cu²⁺, Ni²⁺, and Mn²⁺) was evaluated.

The specific experimental process was as follows: a certain amount of metal salts (lead nitrate (Pb(NO₃)₂), chromium trichloride (CrCl₃), cobalt chloride hexahydrate (CoCl₂·6H₂O), copper chloride (CuCl₂), nickel chloride (NiCl₂), and manganese chloride (MnCl₂)) were respectively weighed and dissolved in water at pH=2 to prepare heavy metal ion aqueous solutions with a concentration of 1000 mg/L as stock solutions, and then the stock solutions of the single heavy metal ions were diluted with pure water to prepare a mixed solution of the six heavy metal ions (each with a concentration of 0.1 mg/L and pH=6) as the working solution. 3 mg of each modified covalent organic frameworks prepared in Examples 1 to 6 and Comparative Examples 2 to 4 and the unmodified covalent organic framework substrate prepared in Comparative Example 1 were weighed into a 50 mL centrifuge tube, and 30 mL of a 0.1 mg/L mixed heavy metal ion aqueous solution was added therein. After shaking at the room temperature for 12 h, the centrifuge tube was centrifuged at 10,000 rpm for 5 min. A supernatant was taken, and the content of six heavy metal ions in the supernatant was determined by ICP-MS. Equilibrium adsorption rates of the heavy metal ions were calculated respectively.

A calculation formula of the equilibrium adsorption rate was as follows:

$$Adsorption rate \% = ( ( {c}_{0} - {c}_{t} ) / {c}_{0} ) \times 100 \%$$

c₀ (mg/L) and cₜ (mg/L) referred to the concentration of heavy metal ions in the solution at initial and time t respectively.

Specific adsorption results were shown in Table 1:

TABLE 1
Adsorption rates of the materials prepared in
Examples 1 to 6 and Comparative Examples 1 to 4
for the six mixed heavy metal ions in the water

| | Adsorption rates (%) | | | | | |
|---|---|---|---|---|---|---|
| Item name | Pb²⁺ | Cr³⁺ | Co²⁺ | Cu²⁺ | Ni²⁺ | Mn²⁺ |
| Example 1 | 91 | 89 | 89 | 99 | 99 | 100 |
| Example 2 | 75 | 96 | 49 | 99 | 44 | 44 |
| Example 3 | 70 | 95 | 72 | 98 | 61 | 88 |
| Example 4 | 60 | 89 | 66 | 92 | 48 | 73 |
| Example 5 | 82 | 27 | 16 | 42 | 29 | 23 |
| Example 6 | 82 | 25 | 18 | 42 | 27 | 23 |
| Comparative | 25 | 16 | 15 | 25 | 18 | 11 |
| Example 1 | | | | | | |
| Comparative | 43 | 29 | 21 | 52 | 23 | 11 |
| Example 2 | | | | | | |
| Comparative | 33 | 27 | 17 | 41 | 20 | 10 |
| Example 3 | | | | | | |
| Comparative | 27 | 15 | 15 | 31 | 15 | 15 |
| Example 4 | | | | | | |

As can be seen from Table 1, compared with unmodified covalent organic framework substrate prepared in Comparative Example 1, the modified covalent organic frameworks prepared in Examples 1 to 4 all showed better adsorption effects on the six heavy metal ions in the mixed multicomponent system. When the concentration of a magnesium chloride modifier was 1 mol/L, the adsorption rate of modified covalent organic framework prepared in Example 1 for the six heavy metal ions was 89% to 100%.

Similarly, in the disclosure, a series of modified covalent organic frameworks (see Example 4, Example 5, and Comparative Examples 2 to 4) were further prepared using neutral solutions (such as sodium chloride and potassium chloride) and alkaline solutions (such as sodium hydroxide, potassium hydroxide, and ammonia water) as modifiers. Adsorption experiment results showed that, compared with the unmodified covalent organic framework substrate in Comparative Example 1, the modification treatment of sodium chloride and potassium chloride on the substrate significantly improved the adsorption effect of the material on Pb²⁺, and also slightly improved the adsorption effect on copper ions, but the adsorption effects on the other four heavy metal ions in the mixed system were still poor; in contrast, the modification treatment of sodium hydroxide, potassium hydroxide, and ammonia water on the substrate only slightly enhanced the adsorption of the copper ions, but the adsorption effects on the other five heavy metal ions in the mixed system were still poor.

The above results fully showed that the modification of magnesium chloride was superior to the treatment with other modifiers. The modification of magnesium chloride significantly enhanced the adsorption capacity of covalent organic framework for multiple mixed heavy metal ions, confirming that the technology provided in the disclosure can prepare modified covalent organic framework with good adsorption effect on multiple heavy metal ions in water within a short period of time. By comparing the chemical structures of covalent organic framework before and after modification, we found that the covalent organic framework substrate structure carried free hydroxyl or carbonyl groups, and an ultrasonic treatment of magnesium chloride did not affect the original free hydroxyl or carbonyl groups on a substrate surface. In addition, the modification of magnesium chloride caused a decrease in the specific surface area of covalent organic framework (BET specific surface areas of the unmodified and modified covalent organic frameworks were 123.3 m²/g and 93.5 m²/g respectively), which showed that the enhanced adsorption capacity of the modified material for multiple heavy metal ions was not attributed to chelation and the specific surface area of the material. Meanwhile, we found that the modified covalent organic framework rapidly adsorbed the heavy metal ions while gradually releasing a large amount of magnesium ions into an adsorption solution. Therefore, the enhanced adsorption effect on the heavy metal ions may be mainly due to the formation of magnesium ionization channels in the covalent organic framework through magnesium chloride modification, achieving rapid and efficient adsorption of the heavy metal ions through ion exchange.

### (IV) Study on Adsorption Processes of Covalent Organic Framework for Multiple Heavy Metal Ions

Hereinafter, the modified covalent organic framework prepared in Example 1 was used as an experimental material to respectively study the adsorption processes of the material in the disclosure on the six heavy metal ions (Pb²⁺, Cr³⁺, Co²⁺, Cu²⁺, Ni²⁺, and Mn²⁺).

### 1. Study on the Influence of the Adsorption Solution pH

### (1) Experimental Method

A certain amount of metal salts (lead nitrate (Pb(NO₃)₂), chromium trichloride (CrCl₃), cobalt chloride hexahydrate (CoCl₂·6H₂O), copper chloride (CuCl₂), nickel chloride (NiCl₂), and manganese chloride (MnCl₂)) were weighed and dissolved in the water at pH=2 to prepare heavy metal ion aqueous solutions with the concentration of 1000 mg/L as the stock solutions. The stock solutions were then diluted with the pure water to prepare single heavy metal ion solutions with the concentration of 0.1 mg/L as the working solutions, and the pH of the working solutions were adjusted with hydrochloric acid or sodium hydroxide of 0.1 mol/L to obtain 0.1 mg/L single heavy metal ion working solutions with different pH (4, 5, 6, 7, and 8). 3 mg of the modified covalent organic framework was accurately weighed and placed in a 50 mL centrifuge tube, and then 30 mL of 0.1 mg/L single heavy metal ion aqueous solution with different pH was added therein and subjected to shaking and adsorbing at room temperature for 12 h. The centrifuge tube was centrifuged at 10,000 rpm for 5 min, and the supernatant was taken to determine the content of the metal ion by using ICP-MS.

### (2) Result Analysis

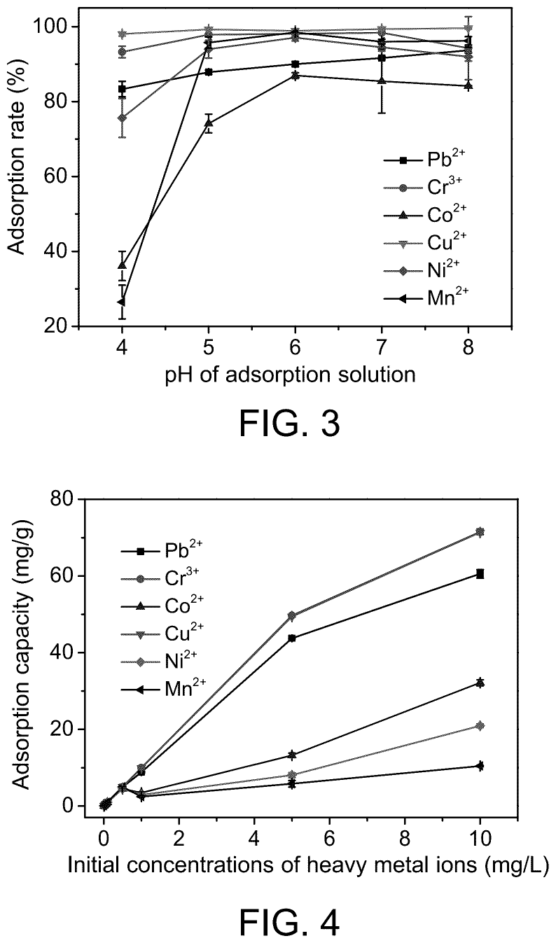

As shown in FIG. 3, when the pH of the adsorption solution was 4, the modified covalent organic framework showed the adsorption effect on the six heavy metals, and the adsorption rates on Pb²⁺, Cr³⁺, Co²⁺, Cu²⁺, Ni²⁺, and Mn²⁺ are 83%, 93%, 36%, 98%, 76%, and 27% respectively. After the pH of the solution was further increased, the adsorption effects of the six heavy metal ions first increased significantly and then showed a slight downward trend. When pH=6, the adsorption capacities of modified covalent organic framework was the highest, and the adsorption rates on Pb²⁺, Cr³⁺, Co²⁺, Cu²⁺, Ni²⁺, and Mn²⁺ are 90%, 98%, 87%, 99%, 97%, and 98% respectively. The above results showed that within a relatively wide pH ranges (4 to 8) of the solution, the modified covalent organic framework showed good adsorption effects for the six heavy metal ions in the water and was suitable for removal and purification of heavy metal ions in a water body.

### 2. Study on Thermodynamic Adsorption Performance

### (1) Experimental Method

A certain amount of metal salts (lead nitrate (Pb(NO₃)₂), chromium trichloride (CrCl₃), cobalt chloride hexahydrate (CoCl₂·6H₂O), copper chloride (CuCl₂), nickel chloride (NiCl₂), and manganese chloride (MnCl₂)) were weighed and dissolved in the water at pH=2 to prepare the heavy metal ion aqueous solutions with the concentration of 1000 mg/L as the stock solutions. The stock solutions were then diluted with the pure water to prepare the mixed heavy metal ion aqueous solutions (pH=6) with concentrations of 0.01, 0.05, 0.1, 0.5, 1, 5, and 10 mg/L respectively as the working solutions. 3 mg of the modified covalent organic framework was accurately weighed and placed in the 50 mL centrifuge tube, and then 30 mL of the mixed heavy metal ion aqueous solutions with different initial concentrations were added therein and subjected to shaking and adsorbing at the room temperature for 12 h. The centrifuge tube was centrifuged at 10,000 rpm for 5 min, and the supernatant was taken to determine the content of the metal ions by using ICP-MS. Equilibrium adsorption capacities for the six heavy metal ions were calculated respectively. The formula for calculating the equilibrium adsorption capacities was as follows:

$$Q = ( {c}_{0} - {c}_{t} ) v / m$$

Q (mg/g) referred to the adsorption capacity of the adsorbent material, c₀ (mg/mL) and cₜ (mg/mL) referred to the initial concentration of the heavy metal ions and the concentration of the ions in the system solution at the time t respectively, v (mL) referred to the volume of the adsorption solution, and m (g) referred to the mass of the adsorbent material.

### (2) Result Analysis

As shown in FIG. 4, in the mixed multicomponent system, within the concentration range of heavy metal ion from 0.01 to 10 mg/L, the adsorption capacities of the modified covalent organic framework for the six heavy metal ions increased continuously with the increase of the initial concentration of heavy metal ions. When the initial concentration of the mixed heavy metal ions was 10 mg/L, the adsorption capacities of modified covalent organic framework for Pb²⁺, Cr³⁺, Co²⁺, Cu²⁺, Ni²⁺, and Mn²⁺ were 61 mg/g, 71 mg/g, 32 mg/g, 71 mg/g, 21 mg/g, and 10 mg/g respectively, and the order of the adsorption capacities of the six heavy metals was Cr³⁺≈Cu²⁺>Pb²⁺>Co²⁺>Ni²⁺>Mn²⁺, which showed that the adsorption of the six heavy metal ions on the surface of modified covalent organic framework in the mixed system had a competitive effect. The modified covalent organic framework showed different degrees of affinity for the six heavy metals in the mixed system. The adsorption capacities for Cr³⁺ and Cu²⁺ was relatively strong, while the adsorption capacities for cobalt ions, nickel ions, and manganese ions was relatively weak. However, regardless of whether the concentration of heavy metal ions was low or high, a good adsorption and removal effect for the six heavy metal ions can be achieved by adjusting the concentration of modified covalent organic framework.

### 3. Study on Kinetic Adsorption Performance

### (1) Experimental Method

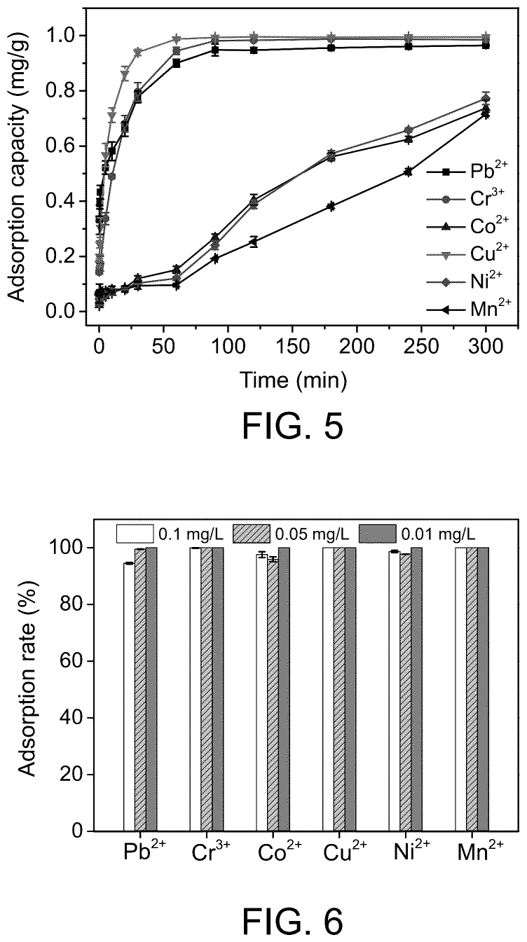

The kinetic adsorption and removal performance of modified covalent organic framework prepared in Example 1 for six heavy metal ions was studied, and the results were shown in FIG. 5.

A certain amount of metal salts (lead nitrate (Pb(NO₃)₂), chromium trichloride (CrCl₃), cobalt chloride hexahydrate (CoCl₂·6H₂O), copper chloride (CuCl₂), nickel chloride (NiCl₂), and manganese chloride (MnCl₂)) were weighed and dissolved in the water at pH=2 to prepare the heavy metal ion aqueous solutions with the concentration of 1000 mg/L as the stock solutions. The stock solutions were then diluted with the pure water to prepare the six mixed heavy metal ion aqueous solutions (pH=6) with a concentration of 0.10 mg/L as the working solution. In the mixed multicomponent system of six heavy metal ions, 3 mg of the modified covalent organic framework was accurately weighed and placed in the 50 mL centrifuge tube, and then 30 mL of 0.1 mg/L mixed heavy metal ion aqueous solution was added therein, and subjected to shaking and adsorbing at the room temperature for different reaction times (10 s, 20 s, 30 s, 1 min, 5 min, 10 min, 20 min, 30 min, 60 min, 90 min, 120 min, 180 min, 240 min, and 300 min). The centrifuge tube was centrifuged at 10,000 rpm for 5 min, and the supernatant was taken to determine the content of the heavy metal ions by using ICP-MS. The equilibrium adsorption capacities of the modified covalent organic framework simultaneously for the six heavy metal ions were calculated respectively, and adsorption and removal capabilities of the modified covalent organic framework for the six heavy metal ions were evaluated.

### (2) Result Analysis

FIG. 5 is a graph showing kinetic adsorption curves of the modified covalent organic framework for the six heavy metal ions (0.1 mg/L) in the mixed multicomponent system. It can be seen from the figure that within the first 30 minutes, the modified covalent organic framework adsorbed Cr³⁺, Cu²⁺ and Pb²⁺ in the mixed system faster, and the adsorption rates were 78 to 94%. These three heavy metal ions could reach equilibrium after 90 minutes of adsorption, while the adsorption of Co²⁺, Ni²⁺ and Mn²⁺ in the mixed system was relatively slow. At 300 minutes, the adsorption rates of Co²⁺, Ni²⁺ and Mn²⁺ could reach 72 to 77%. This indicated that the adsorption capacities of the modified covalent organic framework for Cr³⁺, Cu²⁺ and Pb²⁺ in the mixed system were much greater than those for Cr³⁺, Cu²⁺, and Pb²⁺, which was consistent with the thermodynamic adsorption trend of the six heavy metal ions in the mixed system. In any case, by extending the adsorption time or increasing the amount of adsorbent, the modified covalent organic framework can achieve simultaneous and efficient adsorption and removal for the six heavy metal ions.

### 4. Adsorption and Removal Experiments of the Mixed Heavy Metal Ions with Different Initial Concentrations

### 1. Experimental Method

A certain amount of metal salts (lead nitrate (Pb(NO₃)₂), chromium trichloride (CrCl₃), cobalt chloride hexahydrate (CoCl₂·6H₂O), copper chloride (CuCl₂), nickel chloride (NiCl₂), and manganese chloride (MnCl₂)) were weighed and dissolved in the water at pH=2 to prepare the heavy metal ion aqueous solutions with the concentration of 1000 mg/L as the stock solutions. The stock solutions were then diluted with the pure water to prepare mixed standard solutions of the six heavy metal ions (pH=6) with different concentrations of 0.01, 0.05, and 0.1 mg/L respectively as the working solutions. In the mixed multicomponent system of the six heavy metal ions, 3 mg of the modified covalent organic framework was accurately weighed and placed in the 50 mL centrifuge tube, and then 30 mL of heavy metal ion mixed standard solutions of 0.01, 0.05, and 0.1 mg/L were added therein respectively, and subjected to shaking and adsorbing at the room temperature for 12 h. The centrifuge tubes were centrifuged at 10,000 rpm for 5 min, and the supernatants were taken to determine the content of the heavy metal ions by using ICP-MS. The adsorption rates of the modified covalent organic framework for the six heavy metal ions were calculated respectively, and the simultaneous removal performance of the modified covalent organic framework for the six heavy metal ions was evaluated. Results were shown in FIG. 6.

### (2) Result Analysis

FIG. 6 is a graph showing the adsorption effect of the modified covalent organic framework for the six heavy metal ions with different initial concentrations in the mixed systems. It can be seen from FIG. 6 that when the initial concentrations of the six heavy metal ions in the mixed system were 0.01 mg/L respectively, removal rates of the modified covalent organic framework for the six heavy metal ions were 100%. When the initial concentrations of the six heavy metal ions in the mixed system were 0.05 mg/L respectively, the removal rates of the modified covalent organic framework for the six heavy metal ions were all 96 to 100%, and residual concentrations of Pb²⁺, Cr³⁺, Co²⁺, Cu²⁺, Ni²⁺, and Mn²⁺ were 0.3 μg/L, 0, 2.0 μg/L, 0, 1.1 μg/L, and 0 respectively, which were far lower than the limit values of these heavy metal ions specified in China's national standard GB 5749-2022, “Standards for Drinking Water Quality”. When the initial concentrations of the six heavy metal ions in the mixed system were 0.1 mg/L respectively, the removal rates of the modified covalent organic framework for the six heavy metal ions were all 94 to 100%, and the residual concentrations of Pb²⁺, Cr³⁺, Co²⁺, Cu²⁺, Ni²⁺, and Mn²⁺ were 5.5 μg/L, 0.09 μg/L, 2.4 μg/L, 0, 1.2 μg/L, and 0 respectively, all of which were much lower than the limit values of these heavy metal ions specified in China's national standard GB 5749-2022, “Standards for Drinking Water Quality”. This showed that the modified covalent organic framework synthesized in the disclosure exhibits excellent removal performance for multiple heavy metal ions in the mixed multicomponent coexisting systems and has good practical application value.

Based on the above, the disclosure effectively overcomes deficiencies in the related art and has high industrial application value. The above embodiments are intended to illustrate the essential content of the disclosure, but are not intended to limit the scope of protection of the disclosure. It should be understood by those skilled in the art that the technical solutions of the disclosure may be modified or replaced by equivalents without departing from the essence and the scope of protection of the technical solutions of the disclosure.

What is claimed is:

1. A preparation method of a modified covalent organic framework for simultaneous adsorption of multiple heavy metal ions, comprising the following steps:
(1) dissolving 1,3,5-tris(4-aminophenyl)benzene and 2,5-dihydroxyterephthalaldehyde in a mixed solvent and allowing a reaction to stand at room temperature to obtain a mixed solution;
(2) adding scandium trifluoromethanesulfonate to the mixed solution obtained in the step (1), and allowing a reaction to stand at the room temperature, and after completion of the reaction, separating an insoluble matter from a reaction solution, and then washing and drying the insoluble matter to obtain a covalent organic framework substrate;
(3) using a neutral solution to perform an ultrasonic modification treatment on the covalent organic framework substrate prepared in the step (2), and then washing and drying the modified substrate to obtain the modified covalent organic framework;
wherein the neutral solution in the step (3) is any one of a magnesium chloride aqueous solution, a sodium chloride aqueous solution, and a potassium chloride aqueous solution, and a concentration of the neutral solution is 0.5 to 3 mol/L.

2. The preparation method of the modified covalent organic framework for the simultaneous adsorption of the multiple heavy metal ions according to claim 1, wherein the neutral solution in the step (3) is the magnesium chloride aqueous solution.

3. The preparation method of the modified covalent organic framework for the simultaneous adsorption of the multiple heavy metal ions according to claim 2, wherein a molar ratio of the 1,3,5-tris(4-aminophenyl)benzene to the 2,5-dihydroxyterephthalaldehyde in the step (1) is 2:3.

4. The preparation method of the modified covalent organic framework for the simultaneous adsorption of the multiple heavy metal ions according to claim 3, wherein the mixed solvent in the step (1) is a mixed solvent of 1,4-dioxane and 1,3,5-trimethylbenzene, and a volume ratio of the 1,4-dioxane to the 1,3,5-trimethylbenzene is (1-5): 1.

5. The preparation method of the modified covalent organic framework for the simultaneous adsorption of the multiple heavy metal ions according to claim 4, wherein a molar ratio of the 1,3,5-tris(4-aminophenyl)benzene to the scandium trifluoromethanesulfonate is (10-150): 1.

6. The preparation method of the modified covalent organic framework for the simultaneous adsorption of the multiple heavy metal ions according to claim 1, wherein time for the standing reaction in both the step (1) and the step (2) is 10 to 60 minutes.

7. The preparation method of the modified covalent organic framework for the simultaneous adsorption of the multiple heavy metal ions according to claim 1, wherein a detergent for washing the insoluble matter in the step (2) is at least one of methanol, ethanol, and acetone.

8. A modified covalent organic framework for simultaneous adsorption of multiple heavy metal ions prepared by the method according to claim 1.

9. An application of the modified covalent organic framework according to claim 8 in removal and purification of multiple heavy metal ions in a water body.
